(19) United States
(12) Patent Application Publication
(10) Pub. No.: US 2013/0235494 A1
(43) Pub. Date: Sep. 12, 2013

(54) Integrated Bypass Apparatus, System, and/or Method for Variable-Frequency Drives

(71) Applicants: Kent Jeffrey Holce, Portland, OR (US); Andre Pierre Perra, Portland, OR (US); Scott E. Leonard, Portland, OR (US)

(72) Inventors: Kent Jeffrey Holce, Portland, OR (US); Andre Pierre Perra, Portland, OR (US); Scott E. Leonard, Portland, OR (US)

(21) Appl. No.: 13/605,804

(22) Filed: Sep. 6, 2012

Related U.S. Application Data
(60) Provisional application No. 61/531,612, filed on Sep. 6, 2011.

(51) Int. Cl. H02H 3/08

(52) U.S. Cl. CPC H02H 3/08
USPC 361/31

(57) ABSTRACT

In the field of variable-speed motor control, a bypass circuit and corresponding bypass electronics can be integrated advantageously with a variable-frequency drive (“VFD”) circuit and corresponding electronics. Such an integrated bypass can be disposed within a single unitary enclosure housing the VFD. Some advantages of the integrated bypass include reduced size, cost, and/or complexity in the combined VFD/bypass assembly, the ability to manage airflow in bypass without running a fan motor full time, and support for integrated power metering.

### RELATED APPLICATIONS

This application is a nonprovisional of, and claims the benefit of priority from, U.S. Provisional Patent Application No. 61/531,612, filed Sep. 6, 2011, which is hereby incorporated by reference in its entirety

### COPYRIGHT NOTICE

©2012 Cerus Industrial Corporation. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d), (e).

### TECHNICAL FIELD

The present application is directed to the field of variable-frequency drives for motors that drive equipment such as fans, pumps, and the like, and, in particular, to the field of bypass assemblies and bypass circuits for such variable-frequency drives.

### BACKGROUND

The phrases adjustable-speed, variable-speed, or variable-frequency drive (“VFD”) refer to equipment assemblies that provide a means for driving and adjusting the operating speed of a mechanical load, such as a motor. The motor can be used to drive fans, belts, pumps, or other electromechanical devices. For example, VFDs are very common in heating, ventilation, and air conditioning (HVAC) applications. While variable-frequency drives can be broadly described as including the electric motor, a speed controller or power converter, and/or auxiliary devices and/or equipment, it is also common to use the term VFD to refer to just the corresponding controller.

Because VFDs are electronic devices and coupled to moving components, they are prone to fail, which can be particularly concerning if the VFD is installed in a critical environment and/or applications. In such critical applications, it is known to use a traditional bypass assembly as a solution to provide system redundancy in case of VFD failure. Existing bypass assemblies are added to a VFD installation with an additional enclosure. However, the resulting combined installation is expensive, complicated, bulky, and frequently impractical in many applications and/or installation sites.

In the event the VFD fails, an installed bypass assembly is used to switch the controlled motor to a full-run condition. However, because typical bypass runs the motor at full-speed once it is engaged, additional problems can result. As but one example, in an HVAC application, full-speed motor operation can result in over/under pressurization of the building and ductwork, which can be damaged as a result.

Furthermore, many present “green-building” initiatives and building and/or industrial energy management applications attempt to measure total power consumption by electrical equipment such as VFDs. However, traditional bypass assemblies do not measure power consumption, and installations employing separately added power metering equipment are additionally bulky and cumbersome. Furthermore, such power metering typically measures power output, which is not a true representation of power consumption for the system.

### SUMMARY

Subject matter consistent with the present application can comprise a bypass assembly integrated with a variable-frequency and provisioned in a single unitary enclosure. One advantage of such an integrated bypass is substantially reduced size, cost, and/or complexity in the combined VFD/bypass assembly, compared to traditional installations.

An additional advantage can include the ability to manage airflow with a bypass assembly to ensure sufficient airflow is maintained substantially without running the motor full time. Such improved bypass assemblies can reduce energy consumption, protect duct work from over-pressurization, and improve comfort for building occupants.

A further advantage of integrated bypass assemblies, as disclosed herein, is pre-configured support for integrated metering functionality, suitable for accurate measurement of power consumption in both VFD and bypass modes of operation.

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates one embodiment of a system configuration consistent with the present subject matter.

FIG. 2 illustrates a process flow diagram representing one operating methodology embodiment consistent with the present subject matter.

### DETAILED DESCRIPTION

For purposes of illustrating concepts consistent with the present subject matter, the following description is presented to facilitate discussion. Embodiments disclosed herein are presented for illustrative purposes, and not by way of limitation. Those skilled in the relevant art will readily appreciate that additional, fewer, or alternative components to the various elements described below could be employed without departing from the scope or content of the claimed subject matter.

In the field of variable-speed motor controls, one or more embodiments of bypass circuits and/or corresponding embodiments of bypass electronics can be integrated advantageously with a variable-frequency drive (“VFD”) circuit and/or corresponding electronics. Such an integrated bypass can be disposed within a single unitary enclosure housing the VFD. In the case of an inverter fault, over temperature fault, or other error in the variable-frequency drive, motor operation can be automatically transferred to the bypass to help ensure air delivery, maintain drive life, and for other benefits. Some additional advantages of the integrated bypass can include reduced size, cost, and/or complexity in the combined VFD/bypass assembly, the ability to manage airflow in bypass without full-time running a fan motor, and integrated power metering functionality.

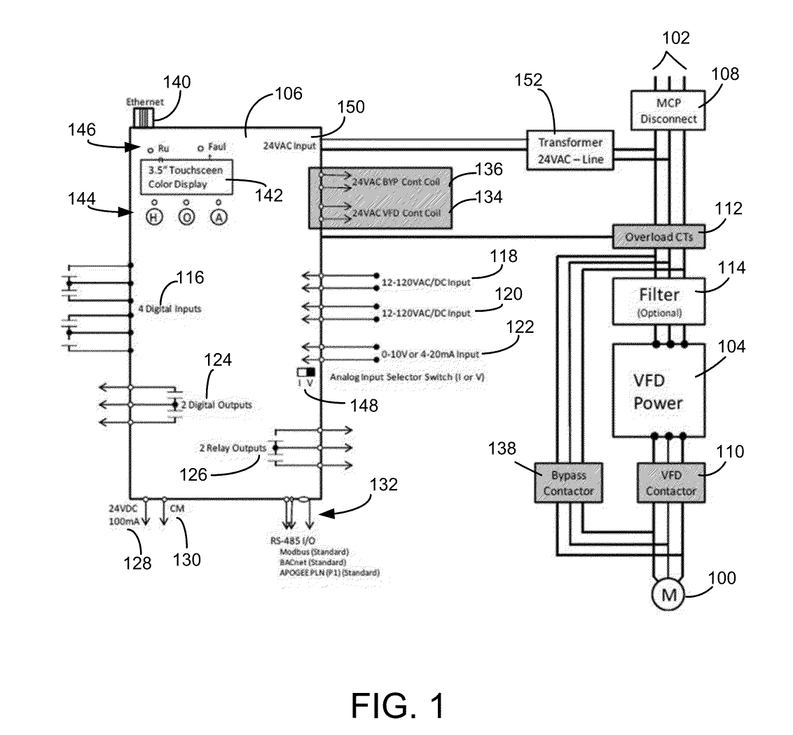

To further illustrate, at least in part, one or more concepts of the present subject matter, FIG. 1 is presented as one embodiment of a system configuration representing one illustrative embodiment of bypass circuitry and/or corresponding electronic components integrated with a variable-frequency drive. With particular reference to FIG. 1, various components typical of a variable-frequency drive are illustrated. For example, FIG. 1 illustrates a motor 100 operating on three-phase, three line power via conductors 102. Variable-frequency drive power 104 is regulated/controlled by a microprocessor-based variable-frequency drive control board 106.

Those skilled in the art will appreciate that the previously mentioned variable-frequency drive components can, in one embodiment, be configured and/or provisioned within a single, unitary housing representing a starter apparatus for motor 100. Additionally, a true disconnect 108 can be included, such that the resulting starter would be suitable for classification as a combination starter. Disconnect 108 can substantially allow line power in conductors 102 to be cut off from the rest of variable-frequency drive system. A variable-frequency drive employing control board 106, and operating to provide starter functionality, can provide for control and protection of motor 100 through additional components including a variable-frequency drive contactor 110 and an overload relay and/or overload protection circuit, which can include current detection circuitry and/or components, such as the current transformers 112 illustrated in FIG. 1. In addition to the variable-frequency drive control board 106 controlling operation of motor 100 through varied application of variable fervency drive power 104, which may additionally include optional filtering 114, microcontroller-based control board 106, operating as a starter embodiment, can protect motor 100 from unsafe thermal operating conditions via the overload current transformers (CTs) 112. If the overload current transformers 112 detect unsafe levels of current the conducting lines 102, the overload relay circuitry integrated with the control board 106 can signal the contacts of the VFD contactor 110 to separate (e.g., by de-energizing a normally energized contactor coil, etc.), in order to cut off motor 100 from the VFD power 104 supplied through the conductor lines 102.

Continuing further with FIG. 1, it will be appreciated that additional input/output and user interface components can be employed for a variable-frequency drive control board 106 based, at least in part, on the specific implementation or environment in which the variable-frequency drive control board 106 is intended to be employed. Those skilled in the art will appreciate that many of the input/output components illustrated in FIG. 1 provide functionality typical to standard variable-frequency drive controllers and/or motor starters providing variable-frequency motor control. For example, control board 106 in FIG. 1 represents several additional inputs, including the illustrated for digital inputs 116 and the signal inputs 118, 120, 122. Additionally, outputs such as the digital outputs 124 and two relay outputs 126 can also be provided as part of the control board 106 interface components. Control board 106 can also include a 24 VDC 100 mA output signal 128 and a CM output 130 as indicated in FIG. 1. For building automation and/or remote control and monitoring functionality, RS-485 I/O and/or additional communications interfaces 132 can also be provided for (e.g., Modbus, BACnet, APOGEE PLN(P1), etc.), to name but a few.

The VFD control board embodiment 106, illustrated in FIG. 1, also illustrates several potential user interface inputs/outputs that could be employed to facilitate installation, operation, maintenance, or other interactive purposes for a user. By way of example, and not by way of limitation, user interface components of variable-frequency drive control board 106, as illustrated in FIG. 1, include Hand-Off-Auto selector buttons 144, a touch screen LCD display 142, a jumper/selector switch 148, as well as indicator pilot lights 146. Of course those skilled in the relevant art will appreciate that additional, fewer, or alternative user interface components could be employed without departing from the scope of the present subject matter. For example, while the pilot light indicators 146 are illustrated as presenting a run indication and a fault indication for the motor, additional information, such as a power indicator could also be included. Control board 106 also includes an Ethernet port 140 which can be provided, at least in part to substantially aid and communications. For example Ethernet port 140 can be used with an attached laptop and/or other mobile computing device. It also could be used with appropriate communications technologies and/or networking components to generate HTML to a web browser for fast setup, cloning of units, or remote monitoring purposes, to name but a few examples.

It should also be appreciated with reference to FIG. 1 that operating power 150 for control board 106 can be obtained, as but one example, directly or indirectly from line power supplied through conductors 102. As operating power 150 in the embodiment illustrated in FIG. 1 is at 24 VAC, and the line power through conductors 102 for a three-phase motor 100 is typically well in excess of that amount (e.g., 480 VAC, etc.), a control power transformer 152 can be employed to step down the line power from conductors 102 to a suitable range for providing control power input 150.

The VFD control board 106 embodiment of FIG. 1 is also illustrated as being configured to produce a contactor coil control signal 134 for controlling the VFD contactor 110 as previously mentioned. In one embodiment control signal 134 is represented as a 24 VAC control signal sufficient to energize, de-energized, and/or otherwise modulate the coil for VFD contactor 110. Similarly, control board 106 can produce a bypass contactor control signal 136 for purposes of controlling a bypass contactor 138 as described in more detail below. Such bypass contactor control signal 136 could also be represented as a 24 VAC signal, as but one example. Those skilled in the art will appreciate that additional and/or alternative signals and/or control methodology could also be used to control one or more contactors to achieve the desired and/or intended functionality.

As FIG. 1 illustrates, if control board 106 indicates a bypass condition is present, power to motor 100 through the conductors 102 can be disconnected via separating contacts of the VFD contactor 110 and power through conductors 102 can be supplied to motor 100 through the circuit path passing through bypass contactor 138. It should be appreciated that, with the configuration illustrated in FIG. 1, regardless of whether motor 100 is operated via VFD contactor 110 or bypass contactor 138, the overload current transformers 112 monitor current supplied to motor 100 via conductors 102.

It should be appreciated that, as illustrated in FIG. 1, embodiments of bypass circuitry and/or bypass components can be strategically integrated with more substantially typical variable-frequency drive circuits and/or components and enclosed in a single unitary enclosure in order to provide the desired functionality with substantially reduced size, cost, and installation complexity. This presents a substantial advantage, in that integrated bypass drives, consistent with the present subject matter, present compact, lightweight, and consolidated electronic assemblies, thus substantially allowing them to fit into smaller locations and/or installation sites.

In addition to the cost, size, and simplified maintenance/installation advantages of integrating bypass functionality with a variable-frequency drive, as previously indicated, it should be appreciated that integrating control circuits and electronic component as illustrated in FIG. 1, can also afford substantial benefits for present embodiments for purposes of control methodologies, energy management, improved equipment life, and power metering. A few illustrative advantages of integrated bypass apparatuses, systems, and/or methods as disclosed herein are described in detail below. However, the following described advantages are presented for illustrative purposes, and not by way of limitation.

One aspect of the novel functionality is related to how a bypass contactor (such as contactor 138 in FIG. 1) is operated in bypass mode, at least in part, to substantially overcome problems typically experienced with traditional bypass assemblies. Additionally, present integrated bypass embodiments can substantially incorporate intelligent management features into the bypass by modulating the bypass contactor within predetermined and/or configurable time intervals, or in response to maintaining a desired pressure (for example, in a PID implementation). Whether it is tied to a pressure sensor with a PID loop, or to a time clock, present bypasses can be operated to achieve specific desired functionality and characteristics. As but one example, in a time interval embodiment, a control board operating in bypass mode can modulate a bypass contactor to run the motor at set intervals (e.g., 10 minutes with the motor on, followed by 10 minutes with the motor off, etc.) as but one example presented for illustration and not intended for purposes of limiting the present subject matter. As such, a substantially average amount (e.g., typical, etc.) of air volume can be delivered to a building during the course of the bypass operation.

Additionally, and/or alternatively, a bypass contactor can be controlled and/or modulated, at least in part, in response to, or in an attempt to maintain, a desired pressure at one or more locations monitored throughout a building (e.g, PID implementation, etc.). For example, a bypass embodiment can control and/or operate the contactor modulation to substantially approximately maintain a desired set point pressure, at least in part, in response to one or more inputs measured by one or more pressure sensors and supplied via an input to a control board operating the bypass. Additionally, present embodiments can include one or more additional controls for advantageously enabling, at least in part, functionality for controlling and/or modulating air duct dampers in order to restrict and/or otherwise manage airflow during bypass operation. A control board, such as control board 106 in FIG. 1, could provide suitable output control signals via one or more appropriately selected signal and/or control output elements (e.g., outputs 124 or 126, 128, 130, etc. from control board 106 in FIG. 1). Of course, if desired, suitable control outputs could be provided to modulate and/or control a supply damper to maintain a desired pressures in either bypass or direct variable-frequency-drive mode operation.

As another example of a control methodology consistent with present bypass embodiments, the VFD controller can initiate a signal and/or command controlling the bypass circuitry as to a desired number of rotations per minute (RPR) intended for the controlled motor. In response, the bypass circuitry can then cycle (e.g., like with a PID loop) the contactor at one or more appropriate intervals in order to, at least in part, try and keep the motor rotations within the intended range measured against a known time clock. Of course, this only represents one possible example of various possible contactor modulation methodologies implementable by an integrated bypass embodiment consistent with the present subject matter.

An additional and/or alternative advantage of present integrated VFD bypass embodiments is exhibited in the field of power measurement and/or metering. Preset integrated bypass embodiments substantially enable power measurement in both the VFD and bypass modes, which also substantially can allow for sub-metering when in bypass mode. Metering and/or data handling can be conducted to a predetermined level and/or standard, such as, for example, 1% ANSI grade metering with comprehensive utility-grade data built right into the drive, as but one example.

With affording the ability to meter the bypass and/or the VFD, present embodiments, such as the integrated VFD bypass circuit embodiment illustrated in FIG. 1, can substantially offer significant value over traditional VFD installations employing non-integrated, add-on bypass configurations. The present embodiments can also facilitate sub-metering of the bypass specifically, which can provide valuable information for energy management considerations or building automation optimization or other considerations. With traditional bypasses, someone who wanted to monitor power at the point of the bypass would be required to buy and install a separate and expensive power meter. Present embodiments, on the other hand, substantially enable power metering as an integrated function, regardless of whether the power is going through the VFD drive or the bypass unit.

This functionality is enabled, in large part, by the placement, configuration, and/or consolidated/combined measurement duties of circuit power measuring elements such as illustrated in FIG. 1. For example, with specific reference to FIG. 1, placement and configuration of the overload CT's 112 and voltage sampled through control power transformer 152 additionally and cooperatively can be used to meter power to the whole circuit, not just at the output. This is regardless of the specific circuit path motor power follows (e.g., voltage and current can be sensed and metered regardless of whether the VFD circuit or the bypass circuit are operating the motor 100).

With standard, commercially available VFD drive technology, a kilowatt-hour power value can be reported for the drive, but it is calculated as a value indicating output power. Such reported values are not representative of the total power consumption for the drive circuit(s).

Conversely, present integrated VFD bypass embodiments can offer the aforementioned functionality as a built-in, integrated feature. Power metering functionality can be accomplished either as a true power measurement using voltage and current measurements enabled by the integrated circuitry, or as an i²t power representation from current measured by the current sensors/CTs employed for purposes of offering overload protection for the VFD and/or bypass circuits. The same circuit components used to provide overload protection can also substantially enable advantageous power metering. This integrated power-metering functionality provides significant advantages over traditional bypass implementations known in the art. It is also worth noting that enabling true power measurement, in addition to just current measurement, can facilitate improved detection of equipment failures such as belt loss, and can facilitate rapid and appropriate alerting of automation systems in the event of the detected error.

Power monitoring is an important part of new legislative efforts, green building initiatives, and other market and/or industry trends, and present embodiments help make power monitoring simple and convenient with combined-purpose circuit elements offering integrated and multi-faceted functionality. This is a significant improvement over power metering conducted on the output of a drive, or having a drive calculate power output, neither of which accurately represent actual power consumed by the electronic drive equipment. Because most existing bypasses or drives are packaged as having two separate control boards, one for the VFD and one for the bypass, it would be counterintuitive for present equipment manufacturers to redesign their drives and/or control boards in a way that would provide the advantageous power metering functionality enabled by embodiments consistent with the present subject matter.

Another novel feature of presently described integrated bypass VFDs is the ability to switch to bypass mode when the VFD is running at or substantially at full speed. This can allow the VFD to turn off while the load (e.g., motor, etc.) is connected directly to the line current. This functionality can be employed, at least in part, to reduce energy consumption, extend VFD life, and reduce harmonics from the VFD system in the building, as well as for other desired reasons.

In certain conditions, VFDs operate under full- or near-full load for extended periods. The control board of present integrated VFD bypass embodiments can detect such operation of the VFD. If temperature in the VFD elements or the conductors increases to an unsafe level, or if the VFD is run at full load extensively, the controller can selectively engage the bypass. This methodology can be used, at least in part, to extend VFD equipment life. Typical bypass assemblies do not offer this important functionality and thus are not as reliable or energy efficient.

Additional functionality, such as the ability to support a fireman's override mode to initiate the purging of smoke from a building, can also be enabled consistent with the present embodiments. Similarly, sleep and wake up functions can be enabled to increase energy savings by deactivating the drive during low-demand times. Pre-heater functionality, can be included with present embodiments to protect the motor and inverters from damage when installed in damp locations and/or environments.

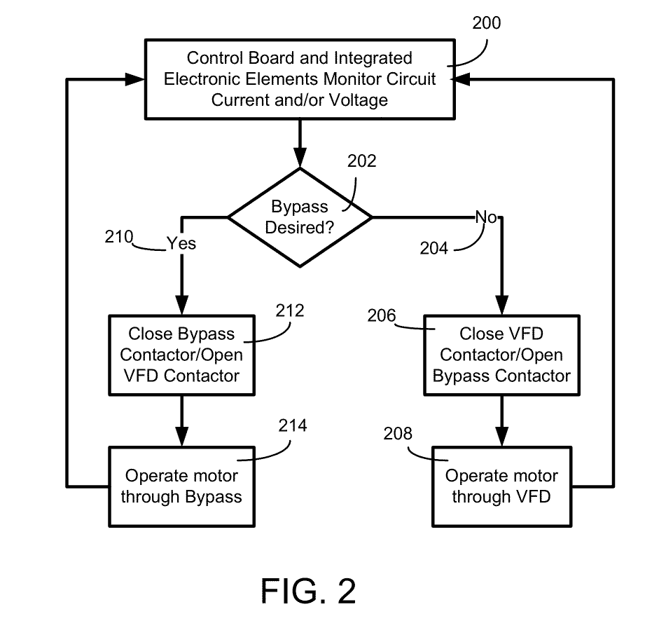

FIG. 2 illustrates one example of a high-level operating methodology embodiment consistent with one or more aspects of the present subject matter as disclosed above. With specific reference to FIG. 2, at step 200 the control board and/or integrated electronic elements can monitor circuit current and/or voltage. At decision 202 it can be determined whether a bypass condition exists and/or a bypass of the VFD is otherwise desired. If decision 202 indicates that no bypass is desired 204, the circuit controller can preferably close VFD contactor and open bypass contactor at step 206 (or ensure they are closed and opened, respectively). The motor can then be operated through the VFD circuit at step 208, at which point the process can return to step 200. Alternatively, if it is determined at decision 202 that a bypass of the VFD is desired 210, then the bypass contactor can be controlled closed and the VFD contactor can be opened at step 212, the motor can then be operated through the bypass circuit at step 214 and the process can return to step 200.

It will be obvious to those having skill in the art that many changes may be made to the details of the above-described embodiments without departing from the underlying principles of the invention. The scope of the present invention should, therefore, be determined only with reference to the claimed subject matter.

1. An integrated bypass apparatus, comprising:
a housing including:
a first contactor provisioned for controlling a motor in a operating mode;
a second contactor provisioned for controlling the motor in a bypass mode;
an overload protection circuit, including one or more current transformers, the overload protection circuit being configured to provide overload protection to the motor in either the operating mode or the bypass mode; and
a microprocessor-based control board including machine-executable instructions for selectively switching between the operating mode and the bypass mode through corresponding modulation of the first contactor and the second contactor.

2. The apparatus of claim 1, further comprising a power meter circuit configured for determining power consumption, the power meter circuit using the one or more current transformers provided for overload protection.

3. A method for selectively operating a bypass circuit in a drive controlling and protecting a motor, the method comprising the steps of:
detecting that a bypass is desired;
modulating a first contactor to cease operation of a motor through a first circuit,
modulating a second contactor to commence operation of the motor through a second circuit, wherein the second circuit bypasses the first circuit;
provisioning overload protection circuit elements such that the motor is protected from overload when the motor is operated by either the first circuit or the second circuit.

4. The method of claim 3, further including the step of measuring power consumption through use of the overload protection circuit elements provisioned for protecting the motor from overload.

5. The method of claim 4, wherein the overload protection circuit elements include current transformers.

6. The method of claim 4, wherein the overload protection circuit elements include current sensors and voltage sensors.

7. The method of claim 4, wherein power consumption can be measured using the overload protection circuit elements when the motor is operated through either the first circuit or the second circuit.

8. A method comprising the steps of:
sensing current supplied via conductors to a motor through either a first contactor or a second contactor, the first contactor and the second contactor being alternately selected for supplying operating power to a motor, whereby the current is sensed for offering overload protection to the motor.
